(19) United States
(12) Patent Application Publication
(10) Pub. No.: US 2013/0020884 A1
(43) Pub. Date: Jan. 24, 2013

(54) POWER-OFF CIRCUIT AND ELECTRONIC DEVICE

(71) Applicants: LU-QING MENG, Shenzhen City (CN); HAI-LONG CHENG, Shenzhen City (CN); CHUN-LUNG HUNG, Tu-Cheng (TW)

(72) Inventors: LU-QING MENG, Shenzhen City (CN); HAI-LONG CHENG, Shenzhen City (CN); CHUN-LUNG HUNG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., ShenZhen City (CN)

(21) Appl. No.: 13/248,054

(22) Filed: Sep. 29, 2011

(30) Foreign Application Priority Data
Jul. 19, 2011 (CN) 201110202421.9

(51) Int. Cl. H02B 1/00

(52) U.S. Cl. 307/126

(57) ABSTRACT

An electronic device includes a processing unit, a power management unit, and a switch. The power management unit is used for receiving a voltage and providing an operating voltage to the processing unit. The switch is connected to the processing unit and the power management unit for generating a power-off signal when being triggered. The processing unit disables the power management unit and is disabled in response to the power-off signal. The power management unit is also disabled according to the power-off signal.

### BACKGROUND

1. Technical Field

The disclosed embodiments relate to power-off circuits, and particularly relates to a power-off circuit and an electronic device.

2. Description of Related Art

Generally, a power-off circuit is incorporated in electronic devices, to power off the electronic devices. A typical electronic device includes a power source, a power management unit, a processing unit, and a button. When the electronic device is powered on, the power source provides a voltage to the power management unit, then the power management unit provides an operating voltage to the processing unit, thus the processing unit operates normally. When a user needs to power off the electronic device, the button is depressed, and then a power off signal is generated. The processing unit disables the power management unit in response to power off signal, and is further disabled in response to power off signal, thus the electronic device is powered off.

However, the processing unit may malfunction, in this situation, the processing unit cannot disable the power management unit in response to power off signal, thus the electronic device cannot be powered off.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout two views.

FIG. 1 is a block diagram of an electronic device in accordance with one embodiment.

FIG. 2 is a circuit diagram of the electronic device in FIG. 1.

### DETAILED DESCRIPTION

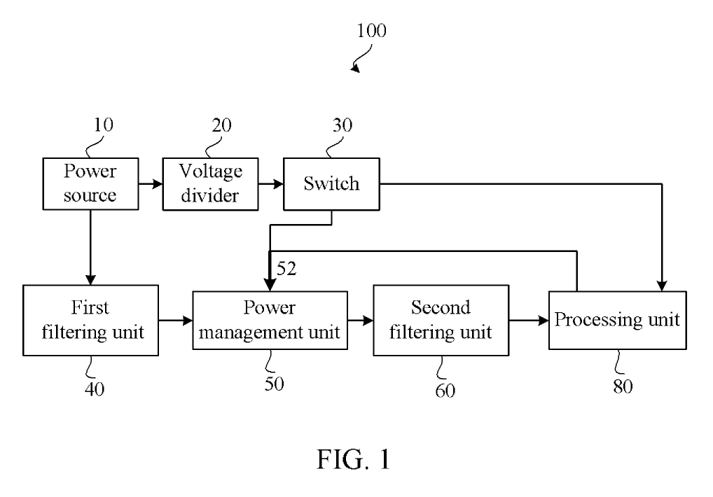

Referring to FIG. 1, an electronic device 100 includes a power source 10, a voltage divider 20, a switch 30, a first filtering unit 40, a power management unit 50, a second filtering unit 60, and a processing unit 80. The power source 10 provides a supply voltage to the voltage divider 20 and the first filtering unit 40. In other embodiments, the power source 10 is external from the electronic device 100.

The voltage divider 20 is used for dividing the supply voltage of the power source 10 and providing the divided voltage to the switch 30. The switch 30 is used for generating a power-on signal or a power-off signal when being triggered. In this embodiment, the power-on signal is the transient divided voltage, and the power-off signal is also the transient divided voltage.

The first filtering unit 40 is used for filtering the supply voltage of the power source 10, and providing the filtered supply voltage to the power management unit 50. The power management unit 50 includes an enable pin 52, and the enable pin 52 is connected to the switch 30 and the processing unit 80. The enable pin 52 receives the power-on signal from the switch 30, thus the power management unit 50 is enabled to provide an operating voltage to the second filtering unit 60. Because the power-on signal is the transient divided voltage, the power management unit 50 is transiently enabled.

The second filtering unit 60 is used for filtering the operating voltage and providing the filtered operating voltage to the processing unit 80, thus the processing unit 80 outputs an enable signal to the enable pin 52 to maintain the power management unit 50 to be enabled, after that, the enable pin 52 can continuously receive the enable signal from the processing unit 80, and the electronic device 100 is powered on.

The processing unit 80 disables the power management unit 50 and is disabled in response to the power-off signal. Because the power-off signal is a transient divided voltage, the enable pin 52 cannot continuously receive the enable signal, and the power management unit 50 is disabled. Therefore, even if the processing unit 80 malfunctions, the processing unit 80 cannot disable the power management unit 50, the power management unit 50 can be disabled according to the power-off signal from the switch 30.

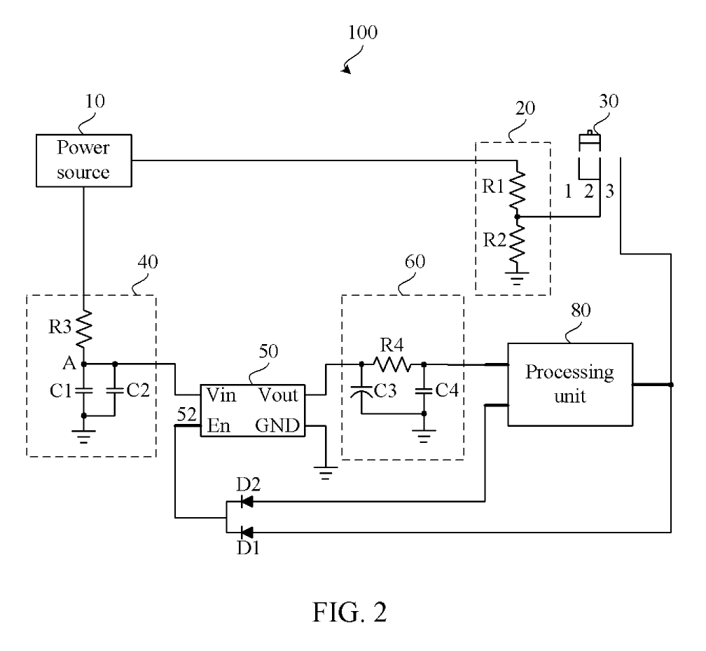

Referring to FIG. 2, the electronic device 100 further includes a first diode D1 and a second diode D2. The voltage divider 20 includes a first resistor R1 and a second resistor R2, one end of the first resistor R1 is connected to the power source 10, the other end of the first resistor R1 is grounded via the second resistor R2.

The switch 30 includes a first pin 1, a second pin 2, and a third pin 3. The first pin 1 is connected between the first resistor R1 and the second resistor R2, the second pin 2 is connected to the first pin 1, an anode of the first diode D1 is connected to the third pin 3, a cathode of the first diode D1 is connected to the enable pin 52. The third pin 3 is further connected to the processing unit 80. When the switch 30 is triggered, the second pin 2 is transiently connected to the third pin 3, and then the second pin 2 is resiliently restored to be connected to the first pin 1. Therefore, the power-on signal is the transient divided voltage, and the power-off signal is also the transient divided voltage.

The first filtering unit 40 includes a third resistor R3, a first capacitor C1, and a second capacitor C2. One end of the third resistor R3 is connected to the power source 10, the other end of the third resistor R3 is grounded via the first capacitor C1. One end of the second capacitor C2 is connected to a node A between the third resistor R3 and the first capacitor C1, the other end of the second capacitor C2 is grounded, the node A is connected to the power management unit 50.

The second filtering unit 60 includes a fourth resistor R4, a third capacitor C3, and a fourth capacitor C4. The fourth resistor R4 is connected between the power management unit 50 and the processing unit 80, one end of the third capacitor C3 is connected between the power management unit 50 and the fourth resistor R4, and the other end of the third capacitor C3 is grounded. One end of the fourth capacitor C4 is connected between the fourth resistor R4 and the processing unit 80, the other end of the fourth capacitor C4 is grounded. Furthermore, an anode of the second diode D2 is connected to the processing unit 80, and a cathode of the second diode D2 is connected to the enable pin 52.

Alternative embodiments will be apparent to those skilled in the art without departing from the spirit and scope of what is claimed. Accordingly, the present disclosure should be deemed not to be limited to the above detailed description, but rather only by the claims that follow and equivalents thereof.

What is claimed is:

1. An electronic device powered by a supply voltage of a power source, the electronic device comprising:
a processing unit;
a power management unit for receiving the supply voltage and providing an operating voltage to the processing unit; and
a switch connected to the processing unit and the power management unit for generating a power-off signal when being triggered;
wherein the processing unit disables the power management unit and is disabled in response to the power-off signal, the power management unit is also disabled according to the power-off signal.

2. The electronic device of claim 1, wherein the switch comprises a first pin, a second pin connected to the first pin, and a third pin; the first pin is connected to the power source, the third pin is connected to the power management unit and the processing unit, when the switch is triggered, the second pin is transiently connected to the third pin, then the second pin is resiliently restored to be connected to the first pin.

3. The electronic device of claim 2, further comprising:
a voltage divider connected between the power source and the first pin;
wherein the voltage divider is used for dividing the supply voltage of the power source and providing the divided voltage to the first pin.

4. The electronic device of claim 3, wherein the voltage divider comprises a first resistor and a second resistor, one end of the first resistor is connected to the power source, the other end of the first resistor is grounded via the second resistor, the first pin is connected between the first resistor and the second resistor.

5. The electronic device of claim 1, further comprising:
a first filtering unit configured to filter the supply voltage, and provide the filtered supply voltage to the power management unit.

6. The electronic device of claim 5, wherein the first filtering unit comprises a third resistor, a first capacitor, and a second capacitor, one end of the third resistor is connected to the power source, the other end of the third resistor is grounded via the first capacitor, one end of the second capacitor is connected to a node between the third resistor and the first capacitor, the other end of the second capacitor is grounded, the node is connected to the power management unit.

7. The electronic device of claim 1, further comprising:
a second filtering unit configured to filter the operating voltage, and provide the filtered operating voltage to the processing unit.

8. The electronic device of claim 7, wherein the second filtering unit comprises a fourth resistor, a third capacitor, and a fourth capacitor, the fourth resistor is connected between the power management unit and the processing unit, one end of the third capacitor is connected between the power management unit and the fourth resistor, the other end of the third capacitor is grounded, one end of the fourth capacitor is connected between the fourth resistor and the processing unit, the other end of the fourth capacitor is grounded.

9. The electronic device of claim 2, further comprising:
a first diode, an anode of the first diode is connected to the third pin of the switch, a cathode of the first diode is connected to the power management unit; and
a second diode, an anode of the second diode is connected to the processing unit, a cathode of the first diode is connected to the power management unit.

10. A power-off circuit for disabling a power management unit, the power-off circuit comprising:
a processing unit for receiving an operating voltage from the power management unit; and
a switch connected to the processing unit and the power management unit for generating a power-off signal when being triggered;
wherein the processing unit disables the power management unit and is disabled in response to the power-off signal, the power management unit is also disabled according to the power-off signal.

11. The power-off circuit of claim 10, wherein the switch comprises a first pin, a second pin connected to the first pin, and a third pin; the first pin is connected to a power source, the power source is used for providing a supply voltage to the power management unit; the third pin is connected to the power management unit and the processing unit, when the switch is triggered, the second pin is transiently connected to the third pin, then the second pin is resiliently restored to be connected to the first pin.

12. The power-off circuit of claim 11, further comprising:
a voltage divider connected between the power source and the first pin;
wherein the voltage divider is used for dividing the supply voltage of the power source and providing the divided voltage to the first pin.

13. The power-off circuit of claim 12, wherein the voltage divider comprises a first resistor and a second resistor, one end of the first resistor is connected to the power source, the other end of the first resistor is grounded via the second resistor, the first pin is connected between the first resistor and the second resistor.

14. The power-off circuit of claim 10, further comprising:
a first filtering unit configured to filter a supply voltage of a power source, and provide the filtered supply voltage to the power management unit.

15. The power-off circuit of claim 14, wherein the first filtering unit comprises a third resistor, a first capacitor, and a second capacitor, one end of the third resistor is connected to the power source, the other end of the third resistor is grounded via the first capacitor, one end of the second capacitor is connected to a node between the third resistor and the first capacitor, the other end of the second capacitor is grounded, the node is connected to the power management unit.

16. The power-off circuit of claim 14, further comprising:
a second filtering unit configured to filter the operating voltage, and provide the filtered operating voltage to the processing unit.

17. The power-off circuit of claim 16, wherein the second filtering unit comprises a fourth resistor, a third capacitor, and a fourth capacitor, the fourth resistor is connected between the power management unit and the processing unit, one end of the third capacitor is connected between the power management unit and the fourth resistor, the other end of the third capacitor is grounded, one end of the fourth capacitor is connected between the fourth resistor and the processing unit, the other end of the fourth capacitor is grounded.

18. The power-off circuit of claim 11, further comprising:
a first diode, an anode of the first diode is connected to the third pin of the switch, a cathode of the first diode is connected to the power management unit; and
a second diode, an anode of the second diode is connected to the processing unit, a cathode of the first diode is connected to the power management unit.

19. An electronic device powered by a supply voltage of a power source, the electronic device comprising:
a processing unit;
a power management unit for receiving the supply voltage, the power management unit comprising an enable pin; and
a switch connected to the processing unit and the enable pin for generating a power-on signal or a power-off signal when being triggered;
wherein the power management unit is enabled to provide an operating voltage to the processing unit in response to the power-on signals, thus the processing unit outputs an enable signal to the enable pin to maintain the power management unit to be enabled; the processing unit disables the power management unit and is disabled in response to the power-off signal, the power management unit is also disabled according to the power-off signal.

20. The power-off circuit of claim 19, wherein the power-off signal is a transient logic high signal.
